(19) United States
(12) Patent Application Publication
(10) Pub. No.: US 2011/0168649 A1
(43) Pub. Date: Jul. 14, 2011

(54) GUN STORAGE RACK

(76) Inventor: GREGORY A. STOLZ, ROSEVILLE, CA (US)

(21) Appl. No.: 12/980,739

(22) Filed: Dec. 29, 2010

Related U.S. Application Data
(60) Provisional application No. 61/293,253, filed on Jan. 8, 2010.

(51) Int. Cl. A47B 81/00; E05B 73/00

(52) U.S. Cl. 211/4; 211/64

(57) ABSTRACT

A gun storage rack comprising an elongated support base mounted on a wall or door. The upper end of the base includes a muzzle housing, and the lower end includes a stock housing. The stock housing has a movable floor, resiliently biased upwardly. Under downward pressure from the stock of a gun, the downward travel of the floor allows the muzzle end of the gun to clear the lower edge of the muzzle housing. Upon release of the pressure, the muzzle enters the muzzle housing. Locking means then restrains the floor in the stock housing from being moved downwardly, effectively locking the upper and lower ends of the gun within the muzzle housing and the stock housing. A selectively positionable trigger housing encloses the lateral portions of the gun's trigger, preventing access thereto. Release of the locking means allows instantaneous removal of the gun from the rack.

### PRIORITY CLAIM

Pursuant to the provisions of 35 U.S.C. §119(e)(1), Applicant claims the priority of U.S. Provisional Patent Application Ser. No. 61/293253, filed Jan. 8, 2010.

### BACKGROUND OF THE INVENTION

1. Field of the Invention

The invention relates generally to improvements in gun storage racks. More particularly, a wall or door mounted gun storage rack includes structurally integrated muzzle, trigger, and stock housings, providing locked safekeeping for storage of a firearm and a quick release feature for its rapid deployment.

2. Description of the Prior Art

Gun racks have a variety of purposes including display, security from theft, and prevention of unauthorized access and use. For example, U.S. Pat. No. 5,791,499, granted to Zebbedies, illustrates a shotgun rack including a support spine 14 having a first support 22 at the stock end, and a second support 24 at the barrel end. A conventional trigger lock 31 may be attached to the support spine to prevent unauthorized use of the firearm.

U.S. Pat. No. 5,129,563, issued to Dillon, shows an Assembly For Mounting A Shotgun To A Car Seat. This arrangement relies upon a gun carrier having a closed position where a stop plate overhangs the open top of the carrier preventing removal of the gun. The carrier also has an open position where the carrier is angled away from the stop plate allowing the gun to be lifted free. The carrier further includes a bottom wall with an opening to accommodate and surround the trigger mechanism of the gun while it is stored.

A Safety Device For Firearms is illustrated in U.S. Pat. No. 5,916,087, granted to Owens. This device includes a mounting plate and a shield, forming an enclosure into which a handgun and a holster are secured. When activated, a solenoid 112 pins a locking section 118 to plate 111, preventing rotation of locking bracket 113. A second purely mechanical lock is also provided, comprising notch 121, bracket 113, and release lever 122. In addition, FIG. 4 shows an alternative embodiment, for storage of a rifle or a shotgun.

U.S. Pat. No. 4,852,780, issued to Woodbury, discloses a portable gun rack for use in motor vehicles. The construction employs an elongated strut including a barrel support block perpendicularly affixed to its upper end. The block has a plurality of U-shaped notches in its surface to accommodate the muzzle of a gun. Hook and loop fasteners are used to secure the muzzle in place. A support box is mounted between the bucket seats to receive the butt of the gun.

A gun caddy is shown in U.S. Pat. No. 4,144,971, granted to Balibrea. This portable device includes a support shaft and a base member at its lower end for supporting the stock end of a rifle or shotgun. Stakes depending from the lower side of the base member are driven into the ground to provide rigidity and stability of the device. The upper end of the support shaft has a grip member configured to accept the barrel of a firearm.

U.S. Patent Application Publication No. 2004/0164036 A1, filed by Cummins, shows a rotatable gun storage carousel. A vertical oriented main post 102 has a lower end affixed to a base 104. Slots 110 are provided in the base, for receiving rifle butts stored in the carousel. A center wing 106 includes cutouts 112 for receiving rifle barrels.

### SUMMARY OF THE INVENTION

The present invention comprises a gun storage rack having an elongated support base for convenient mounting on a wall or a door. The upper end of the support base includes a muzzle housing which is sized and configured to accommodate the muzzle end of a gun, such as a rifle or a shotgun. The lower end of the support base includes a stock housing which is sized and configured to accommodate the stock end of the gun. The stock housing has a movable floor, which is resiliently biased upwardly through the use of springs, or other equivalents. Guide means may be provided to maintain the movable floor and the bottom floor of the stock housing in generally parallel relation, as the floor moves upwardly and downwardly.

Under downward pressure from the stock of a gun inserted into the stock housing, the floor is urged downwardly. The downward travel of the floor allows the muzzle end of the gun to clear the lower edge of the muzzle housing, and be centered on the lower, open end of the muzzle housing. Upon release of the downward pressure on the gun, the muzzle end is moved upwardly to enter the muzzle housing. Locking means is then actuated, restraining the floor in the stock housing from being moved downwardly. This, in turn, effectively locks the upper and lower ends of the gun respectively within the muzzle housing and the stock housing.

A selectively positionable trigger housing is also secured to the support base, between the muzzle housing and the stock housing. The trigger housing encloses lateral portions of the gun adjacent and surrounding the trigger mechanism, preventing access thereto. Since the gun is locked in the rack with its trigger mechanism inaccessible, the gun can safely be stored in a loaded condition.

Release of the locking means frees the movable floor for vertical translation. Applying downward pressure on the gun depresses the movable floor downward a sufficient amount so the gun's muzzle clears the lower edge of the muzzle housing. Then, drawn outwardly from the rack and lifted upwardly, the gun is free from the muzzle housing, the trigger housing, and the stock housing, and ready for use.

An alternative embodiment includes a combined stock and trigger housing, that accommodates and encloses the stock, trigger, and external magazine of a gun such as an assault rifle. The combined stock and trigger housing prevents access to both the trigger and the magazine of the assault rifle, while it is in a locked condition for storage.

### BRIEF DESCRIPTION OF THE DRAWINGS

FIG. 1 is a perspective view of the Gun Storage Rack, showing a gun being inserted into the stock housing;

FIG. 2 is a cross-sectional view, taken on the line 2-2, in FIG. 1;

FIG. 3 is a perspective view as in FIG. 1, but showing the stock end of the gun fully inserted into the stock housing, urging the movable floor therein downwardly;

FIG. 4 is a cross-sectional view, taken on the line 4-4, in FIG. 3;

FIG. 5 is a perspective view showing a gun installed into the Gun Storage Rack, the locking pin being inserted through an aperture in the sidewall of the stock housing for engagement with a bore in the movable floor;

FIG. 6 is a cross-sectional view, taken on the line 6-6, in FIG. 5;

FIG. 7 is a cross-sectional view taken through the stock housing, showing one version of the locking mechanism for the movable floor;

FIG. 8 is a cross-sectional view taken through the base plate, showing how it is attached to a wall and a wall stud;

FIG. 9 is a fragmentary perspective view of the stock housing and the stock of a gun showing the locking mechanism being released to allow the gun to be withdrawn from the Gun Storage Rack;

FIG. 10 is a side elevational view showing the adjustable positioning feature for both the muzzle housing and the trigger housing, to accommodate firearms having different lengths from muzzle end to stock end;

FIG. 11 is a fragmentary perspective view of the stock housing fitted with another version of the locking mechanism, having an electronic combination lock feature;

FIG. 12 is a fragmentary, cross-sectional view of the locking mechanism shown in FIG. 11, showing the locking pin being withdrawn;

FIG. 13 is a perspective view of an alternative embodiment of the Gun Storage Rack including a combined stock and trigger housing;

FIG. 14 is a side elevational view of the Rack shown in FIG. 13, showing a stored assault rifle in broken line, the trigger and magazine of the rifle being enclosed by the stock and trigger housing and the electronic combination lock being eliminated for clarity; and,

FIG. 15 is a fragmentary, cross-sectional view taken on the line 15-15 in FIG. 13.

### DETAILED DESCRIPTION OF THE PREFERRED EMBODIMENT

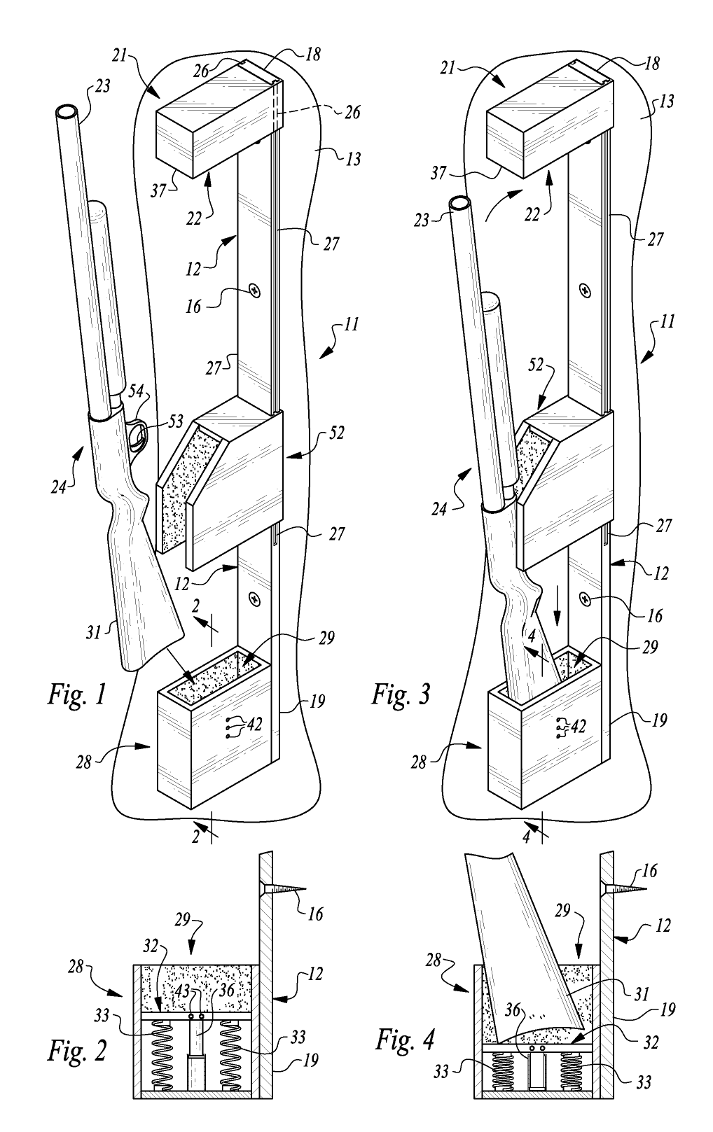

Turning now to FIG. 1, the gun storage rack 11 comprises an elongated support base 12, adapted to be mounted on mounted on a wall 13 or a door 14 (See, FIG. 5). Conventional screws 16 are used to mount the base 12, and in the case of a wall mount, screws 16 preferably extend into wall studs 17 for additional security. Base 12 is preferably fabricated from a metal strip of aluminum or steel, and includes an upper end 18 and a lower end 19.

The upper end 18 of support base 12 includes a muzzle housing 21, having an open, downwardly facing bottom portion 22. Bottom portion 22 is sized and configured to accommodate the muzzle end 23 of a gun 24. The inner end of muzzle housing 21 is provided with ribs 26 on opposing sides, facing inwardly toward and engaging with respective channels 27 extending along opposing edges of base 12. The interior walls of muzzle housing 21 may be provided with foam or cloth padding (not shown) to protect the muzzle end 23 from being scratched or marred.

The lower end 19 of support base 12 includes stock housing 28, having an open, upwardly facing top portion 29. Top portion 29 is sized and configured to accommodate the stock end 31 of the gun 24. Stock housing 28 is preferably permanently affixed to support base 12, but alternatively, a vertically adjustable mounting arrangement could be employed to accommodate guns of different overall length. As is shown particularly in FIGS. 2, 4 and 6, stock housing 28 is provided with a movable floor 32 which is resiliently biased upwardly. This is accomplished through the use of one or more springs 33, extending from a bottom floor 34 in the housing 28 to the underside of movable floor 32. Other structural equivalents, such as pneumatic or hydraulic means, or an underlying layer of resilient material, could also be substituted in the same location with identical results.

Guide means 36 may also be provided in housing 28 to maintain the movable floor 32 and the bottom floor 34 of the housing in generally parallel relation, as the floor 32 moves upwardly and downwardly. As shown in the drawings, this may be accomplished through the use of a telescoping tube assembly This particular construction for guide means 36 is centrally positioned within the housing 28, interconnecting bottom floor 34 with the underside of movable floor 32. Structural equivalents include vertically extending rails, channels, rollers, and the like, mounted on the movable floor 32 and the interior walls of the stock housing 28. These alternative constructions would be equally effective in maintaining movable floor 32 in parallel relation to the bottom floor 34, as it is translated upwardly and downwardly.

When the gun storage rack 11 is unloaded, as shown in FIG. 1, the movable floor 32 is resiliently biased upwardly into an upper released position. (See, FIG. 2). When the user is ready to load gun 24 into the rack, the stock end 31 is inserted into the stock housing 28. Then, as downward pressure is applied on the gun, the downward travel of the movable floor 32 allows the gun's muzzle end 23 to clear the lower edge 37 of the muzzle housing 21. At this point, the movable floor is depressed into a gun loading position, as shown in FIG. 4. When the muzzle end is positioned below the open bottom portion 22, the pressure on the resilient bias means is released, allowing the gun to moved slightly upwardly as the muzzle end 23 enters the muzzle housing 21.

Locking means 38 is also provided to secure the gun 24 within the gun storage rack 11 so that it cannot be removed by unauthorized users or thieves. Locking means 38 comprises a locking pin 39 used in combination with a grip 41 having a centrally positioned magnet 40. A plurality of apertures 42 are provided in the sidewall of the stock housing 28, for passage of pin 39. The vertical line of apertures 42 is provided to accommodate different vertical positions for movable floor 32 when it is ready to be locked into position, as will be more apparent from the discussion below.

At least one bore 43 is included in movable floor 32, for engagement by the locking pin 39. One or more recesses 44 may be provided in the opposing sidewall of housing 28, to accommodate the distal end of locking pin 39, providing additional strength once the pin is inserted. (See, FIGS. 5 and 7). Each recess 44 corresponds in vertical position to a respective aperture on the opposite side of housing 28.

Locking means 38 may also be located on the opposite side of housing 28, in the event the right hand side of gun storage rack 11 is mounted close to a wall or other structure, limiting access on that side. This alternative arrangement for locking means 38 is indicated in broken line in FIG. 7.

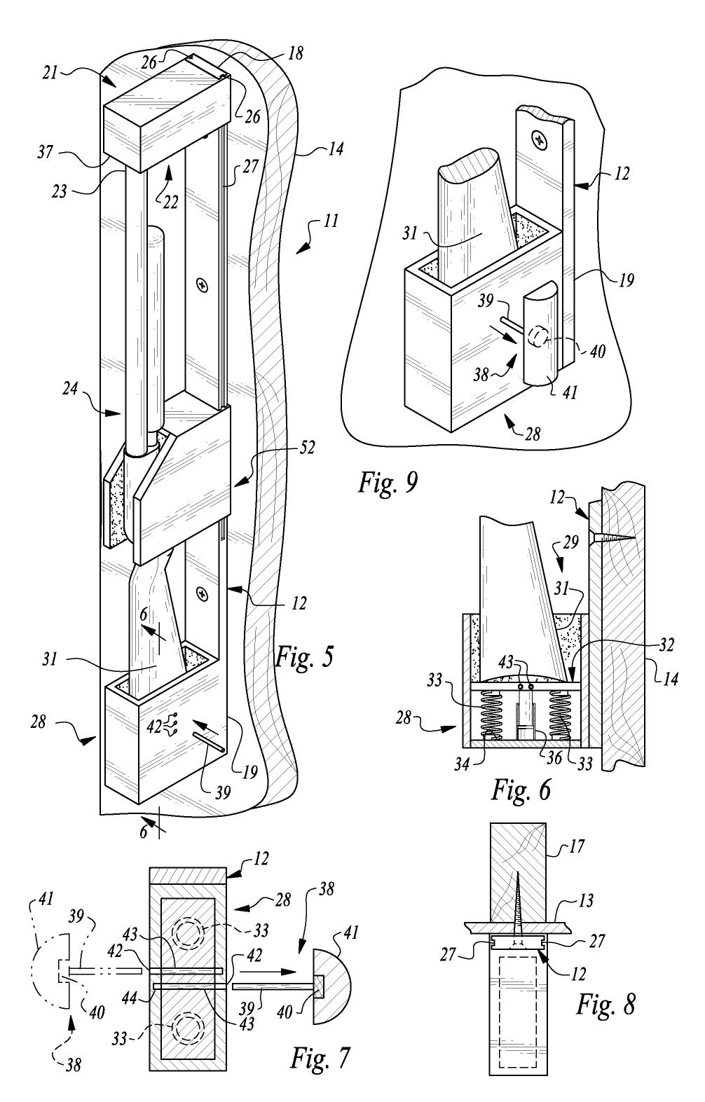

In preparation for locking the gun 24 within the rack 11, the user selects a particular aperture 42 for hand insertion of the pin 39. The proper aperture 42 will be the one that aligns with bore 43. It should be understood that depending upon the weight and length of the gun 24, bore 43 may be aligned with a different aperture 42, as the movable floor 32 may be located at different heights. Upon selection of the proper aperture 42 and full insertion of pin 39, locking means 38 is effective to restrain movable floor 32 from being moved downwardly. Moreover, the proximal end of locking pin 39 is flush with the sidewall of stock housing 28, making it impossible to grasp and remove. With the muzzle end 23 of the gun secured within the muzzle housing 21, and the stock end 31 of the gun secured within the stock housing 28, the gun cannot be removed from the gun storage rack 11. FIG. 6 shows the relative position of movable floor 32 in its lower locked position, with locking means 38 actuated.

For removal of the gun 24 from the rack 11, the user first locates grip 41. Magnet 40, centered on the inner face of grip 41, is then moved into close proximity with the proximal end of locking pin 39. The magnetic forces are effective to entrap locking pin 39, so that withdrawal of grip 41 away from stock housing 28 will also draw pin 39 outwardly for complete removal therefrom. (See, FIGS. 7 and 9). Release of the locking means frees movable floor 32 so it may again be depressed into a lower position. Applying downward pressure on the gun 24 urges movable floor 32 downward a sufficient amount so the gun's muzzle clears the lower edge 37 of the muzzle housing 21. Then, the gun 24 is drawn outwardly from the rack 11 and lifted upwardly. Free from the muzzle housing 21, the trigger housing 52, and the stock housing 28, the gun 24 is ready for use.

An even more secure locking means 46 is shown in FIGS. 11 and 12. In this arrangement, an electronic combination lock 47 includes a locking pin 48. An aperture 49 is provided in a sidewall of stock housing 28, for passage of locking pin 48. A bore 51 is provided in movable floor 32 to accommodate pin 48 when it is inserted through bore 51, placing movable floor 32 in a locked condition. When the proper combination is entered into lock 47, pin 48 may be withdrawn by magnetic forces using grip 41, as described above. With pin 48 removed from bore 51, movable floor 32 is free for downward movement and removal of gun 24.

It is apparent that electronic combination lock 47 could include a solenoid for powered extension and retraction of pin 48. In addition, a mechanical combination lock could readily be substituted for electronic combination lock 47, providing identical functionality and structural equivalency. Other equivalent structures for locking movable floor 32 in place would include any mechanical impediment to its downward travel, such as a shelf, a boss, a rod, or the like that could selectively be deployed beneath movable floor 32 for locking its position.

A selectively positionable trigger housing 52 is also provided to complete the security and safety features of the gun storage rack 11. When the gun 24 is secured within rack 11, the various sidewalls of trigger housing 52 effectively enclose its trigger 53 and trigger guard 54, preventing access to these components. It should be noted that trigger housing 52 also includes ribs (not shown) on opposing sides of its inner end. These ribs face inwardly toward and engage with respective channels 27 in support base 12, in a fashion identical to corresponding components on muzzle housing 21. This construction allows selectively adjustable positioning of trigger housing so it can be located precisely over the trigger and trigger guard components, irrespective of the length of the gun and without regard to where these components may be located along its length. Screws or other locking mechanisms, inaccessible when the gun 24 is stored in the rack, secure the trigger housing 52 in place.

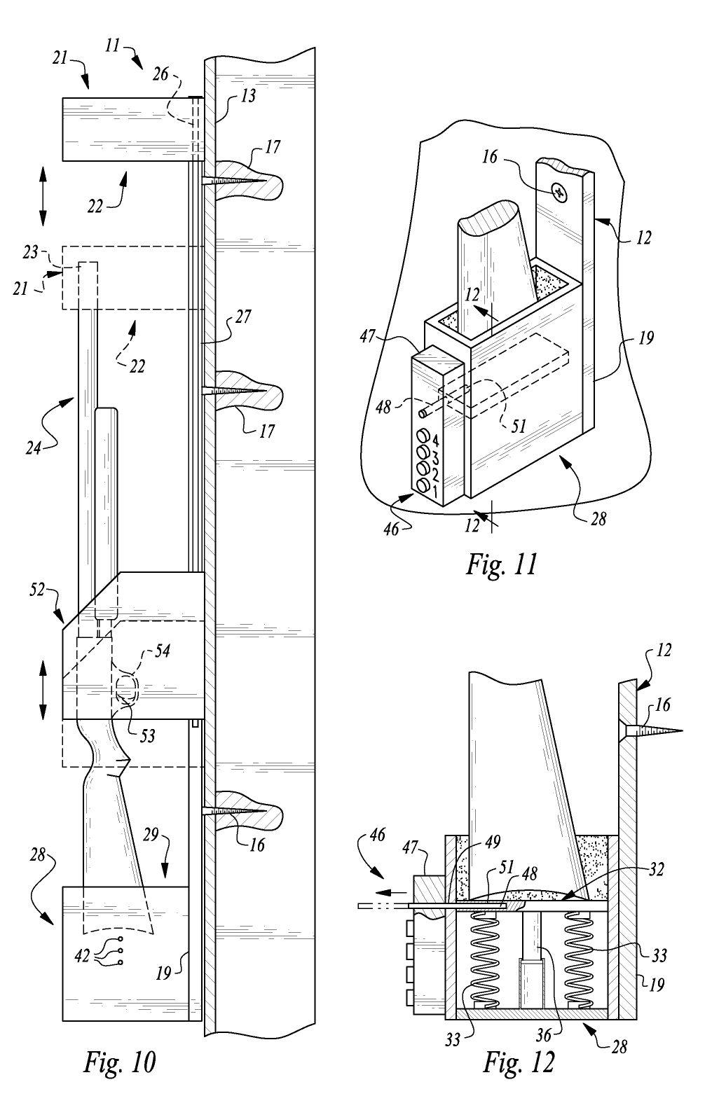

In order to accommodate guns of different lengths, muzzle housing 21 is also provided with the same adjustability and selectively lockable features enjoyed by trigger housing 52. As previously described, ribs 26 on the inner end of housing 21 slide within channels 27, providing vertical adjustment of the housing 21 along support base 12. FIG. 10 illustrates in particular, the adjustability features of the housings 21 and 52. For a shorter gun, both housing 21 and housing 52 are moved into lower, alternative positions, represented by broken line in FIG. 10, and then locked into place. In that manner, the gun storage rack 11 can advantageously be adjusted and adapted for shotguns and rifles having different overall lengths, and different locations for their actuating trigger mechanisms.

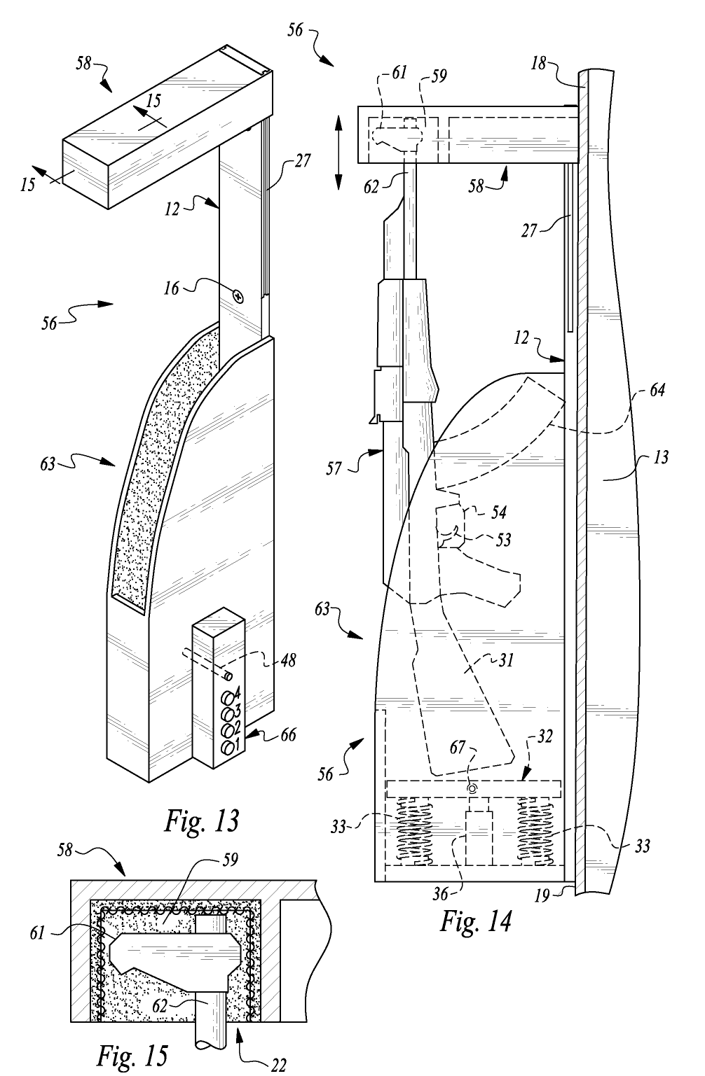

Gun storage rack 56, shown in FIGS. 13-15, represents an alternative embodiment of the invention, specially adapted to store an assault rifle 57. Where structure corresponding to that previously described is used in gun storage rack 56, identical identifying numerals will be used in the description of this embodiment. And, with several exceptions noted below, the operation of gun storage rack 56 is identical to that for gun storage rack 12, so those aspects will not be repeated for the sake of brevity.

The elongated support base 12 includes muzzle housing 58 at its upper end 18. Muzzle housing 58 is vertically adjustable along channels 27, to accommodate rifles of different overall length. The interior of muzzle housing 58 includes a padded compartment 59 to accommodate the larger forward sight 61 of assault rifle 57. Muzzle housing 58 is also somewhat longer than muzzle housing 21, owing to the greater horizontal distance between muzzle end 62 and support base 12.

A combined stock and trigger housing 63 is secured to support base 12, extending vertically from the lower end 19 approximately ⅔ of its length. Stock and trigger housing 63 is sized and configured to accommodate and enclose not only the stock 31 and trigger 53 of the rifle 57, but also the magazine 64. In this manner, the side and front walls of housing 63 prevent access to dangerous actuating components of the rifle 57.

The stock and trigger housing 63 also has a movable floor 32 which is resiliently biased upwardly by springs 33. Guide means 36 is also provided to ensure smooth upward and downward vertical excursions of movable floor 32. Movable floor 32 also has a lower locked position and an upper released position, which respectively function to maintain the rifle 57 in a locked condition for storage and to effect a released condition for immediate removal and deployment. Locking and release of movable floor 32 is effected by an electronic combination lock 66, shown in FIG. 13. In this arrangement, a locking pin 48 extends from the lock 66 to engage a bore 67, extending transversely through floor 32.

What is claimed is:

1. A gun storage rack comprising:
a. an elongated support base, said support base having an upper end and a lower end;
b. a muzzle housing secured to said upper end of said support base;
c. a stock housing secured to said lower end of said support base, said stock housing having a movable floor, said floor being resiliently biased upwardly and having a lower locked position and an upper released position; and,
d. locking means for selectively securing said floor in said lower locked position and releasing said floor to be biased upwardly into said upper released position, whereby under downward pressure from the stock of a gun, the downward travel of the floor allows the muzzle end of the gun to clear a lower edge of the muzzle housing and upon release of said downward pressure, the muzzle is urged upwardly by said resilient bias to enter said muzzle housing, and said locking means is actuated to restrain said floor from being moved downwardly, locking the muzzle end and the stock end of the gun respectively within the muzzle housing and the stock housing.

2. A gun storage rack as in claim 1 in which release of said locking means allows the gun to be moved downwardly so that the muzzle clears said lower edge of said muzzle housing, allowing instantaneous removal of the gun from the gun storage rack.

3. A gun storage rack as in claim 1 further including a selectively positionable trigger housing secured along said support base between said muzzle housing and said stock housing, said trigger housing enclosing lateral portions of the gun adjacent and around the trigger, preventing access thereto.

4. A gun storage rack as in claim 1 in which said muzzle housing is selectively positionable along said support base to accommodate guns having different lengths from muzzle end to stock end.

5. A gun storage rack as in claim 1 in which said support base is attached either to a wall or to a door.

6. A gun storage rack as in claim 1 in which said movable floor is resiliently biased by at least one spring.

7. A gun storage rack as in claim 6, further including at least one telescoping guide rod extending between said stock housing and said movable floor, said guide rod being effective to maintain said movable floor in parallel relation to a bottom floor of said housing, when said movable floor moves between said lower locked position and said upper released position.

8. A gun storage rack as in claim 1 in which said locking means comprises at least one pin, said pin extending through an aperture in a side wall in said stock housing to register within a bore in said movable floor when said floor is in said lower locked position.

9. A gun storage rack as in claim 1 in which said locking means comprises a combination lock, said combination lock having a locked condition for extending a pin through an aperture in a side wall in said stock housing to register within a bore in said movable floor securing said floor in said lower locked position, and having an unlocked condition for withdrawing said pin from said bore allowing said resiliently biased movable floor to move upwardly into said upper released position.

10. A gun storage rack comprising:
a. an elongated support base, said support base having an upper end and a lower end;
b. a muzzle housing secured to said upper end of said support base, said muzzle housing being sized and configured to accommodate a muzzle of a gun;
c. a stock housing secured to said lower end of said support base, said stock housing being sized and configured to accommodate a stock of the gun, said stock housing further having a movable floor, said floor being resiliently biased upwardly and having a lower locked position and an upper released position;
d. a selectively positionable trigger housing secured along said support base between said muzzle housing and said stock housing, said trigger housing enclosing lateral portions of the gun adjacent and around the trigger, preventing access thereto; and,
e. a lock attached to said stock housing, said lock having a locked condition for selectively securing said movable floor in said lower locked position and an unlocked condition for releasing said movable floor so it is free to be biased upwardly into said upper released position.

11. A gun storage rack as in claim 10 in which release of said lock allows the gun to be moved downwardly so that the muzzle clears a lower edge of said muzzle housing, allowing instantaneous removal of the gun from the gun storage rack.

12. A gun storage rack as in claim 10 in which said muzzle housing is selectively positionable along said support base to accommodate guns having different lengths from muzzle end to stock end.

13. A gun storage rack as in claim 10 in which said support base is attached either to a wall or to a door.

14. A gun storage rack as in claim 10 in which said movable floor is resiliently biased by at least one spring.

15. A gun storage rack as in claim 10 in which said lock comprises at least one pin, said pin extending through an aperture in a side wall in said stock housing to register within a bore in said movable floor when said floor is in said lower locked position.

16. A gun storage rack as in claim 10 in which said lock comprises a combination lock, said combination lock having a locked condition for extending a pin through an aperture in a side wall in said stock housing to register within a bore in said movable floor securing said floor in said lower locked position, and having an unlocked condition for withdrawing said pin from said bore allowing said resiliently biased movable floor to move upwardly into said upper released position.

17. A gun storage rack comprising:
a. an elongated support base, said support base having an upper end and a lower end;
b. a muzzle housing secured to said upper end of said support base, said muzzle housing being sized and configured to accommodate a muzzle of a gun;
c. a combined stock and trigger housing secured to said lower end of said support base, said stock and trigger housing being sized and configured to accommodate and enclose both the stock and the trigger of the gun, said stock and trigger housing further having a movable floor, said floor being resiliently biased upwardly and having a lower locked position and an upper released position; and,
d. a lock attached to said stock and trigger housing, said lock having a locked condition for selectively securing said movable floor in said lower locked position and an unlocked condition for releasing said movable floor so it is free to be biased upwardly into said upper released position.

18. A gun storage rack as in claim 17 in which the gun has a magazine extending therefrom, and in which said stock and trigger housing accommodates and encloses the magazine.

19. A gun storage rack as in claim 17 in which said lock comprises at least one pin, said pin extending through an aperture in a side wall in said stock and trigger housing to register within a bore in said movable floor when said floor is in said lower locked position.

20. A gun storage rack as in claim 17 in which said lock comprises a combination lock, said combination lock having a locked condition for extending a pin through an aperture in a side wall in said stock housing to register within a bore in said movable floor securing said floor in said lower locked position, and having an unlocked condition for withdrawing said pin from said bore allowing said resiliently biased movable floor to move upwardly into said upper released position.
